(19) United States
(12) Patent Application Publication
(10) Pub. No.: US 2022/0187724 A1
(43) Pub. Date: Jun. 16, 2022

(54) TONER HAVING SPECIAL SURFACE FEATURES AND METHOD TO MAKE THE SAME

(71) Applicant: LEXMARK INTERNATIONAL, INC., LEXINGTON, KY (US)

(72) Inventors: JING X. SUN, LEXINGTON, KY (US); QING ZHANG, LEXINGTON, KY (US); BENJAMIN KEITH NEWMAN, LEXINGTON, KY (US); CORY NATHAN HAMMOND, WINCHESTER, KY (US); LIGIA AURA BEJAT, LEXINGTON, KY (US)

(21) Appl. No.: 17/123,693

(22) Filed: Dec. 16, 2020

(51) Int. Cl. G03G 9/08; G03G 9/093; G03G 9/09; C08F 212/08; C08F 220/18; C08F 220/20; C08F 220/28

(52) U.S. Cl. CPC G03G 9/0806; G03G 9/09364; G03G 9/09321; G03G 9/09371; G03G 9/09; C08F 212/08; C08F 2/22; C08F 220/20; C08F 220/1804; C08F 220/281; G03G 9/0815; G03G 9/0825; C08F 220/1812

(57) ABSTRACT

The present disclosure relates to a polyester chemically produced toner composition including a core shell toner particle having special surface features and method to make the same. The special surface features on the outer surface of the core shell toner particle are created by the incorporation of a specially designed polymer latex having styrene and acrylate monomers into the core or shell of the toner particle wherein the polymer latex having styrene and acrylate monomers is tailored to be incompatible with the polyester resin(s) found in the core or the shell of the toner particle.

### CROSS REFERENCES TO RELATED APPLICATIONS

None.

### BACKGROUND

### 1. Field of the Disclosure

The present disclosure relates to a polyester chemically produced toner composition including a core shell toner particle having special features and method to make the same. The special surface features on the outer surface of the core shell toner particle are created by the incorporation of a specially designed styrene acrylic latex into the core of shell of the toner particle wherein the styrene acrylic latex is tailored to be incompatible with the polyester resin(s) found in the core or shell of the toner particle. The resulting toner particle has a similar narrow charge distribution compared to toners having expensive extra particular additives.

### 2. Description of the Related Art

Controlling the charge of toners used in both single component development and dual component development electrophotographic printing is a significant objective. It is desirable that toners used in both single component development and dual component development electrophotographic printing possess a stable charge and narrow charge distribution throughout their entire life. Toners possessing this narrow charge distribution will maintain good chargeability, charge stability and charge distribution. Toners having these desirable characteristics provide many advantages in electrophotographic printing including better process control, less contaminant of the parts of the electrophotographic printer, reduced toner usage, reduced cost of printing and improved print quality.

Toner charging can be dependent on the use of extra particulate additives (EPAs) found on the surface of the toner. EPAs are attached on the surface of the raw toner particle through mechanical blending and maintained on this surface through Van der Waals forces. The use of EPAs on the surface of the raw toner particle improves the flowability of the toner particles and maintains a desirable charge and charge range of the toner particles. Moreover, to achieve this desired charge and a narrow charge range for the toner particles, most toner formulations use a plurality of different sized of EPAs in combination with EPAs having a specially treated surface. The use of this EPA package increases the total cost of toner in terms of the additional raw material cost as well as the additional manufacturing costs to add the EPA package to the outer surface of the toner particle. In addition, it is desirable that the EPA package stay on the toner surface through the end of life of the toner. If the EPAs dislodge from the toner surface or become embedded below the toner surface, the toner charge will not be maintained at the same level as when the EPAs were located on the outer surface of the toner particle.

Another method to control the charge of the toner is the use of a charge control agent. Like the EPA package, charge control agents are expensive and will increase the overall cost of the toner. Additionally, introducing the charge control agent into the chemically processed toner manufacturing process is limiting because the charge control agent is not soluble in both aqueous and monomer solutions and has difficulty forming aqueous emulsions. Therefore, it would be desirable to control the toner base powder's charge and charge distribution without the use of expensive charge control agents and multiple EPAs. Meanwhile, controlling the charge distribution of the raw toner particles will result in a uniform charge distribution which benefits toner usage, print quality and print uniformity.

### SUMMARY

### Brief Description of the Drawings

The accompanying drawings incorporated in and forming a part of the specification illustrate several aspects of the present disclosure and together with the description serve to explain the principles of the present disclosure.

FIG. 1 is a scanning electron image, in accordance with the prior art, of a core shell toner particle having no special surface features.

FIG. 2 is a scanning electron image, in accordance with the prior art, of a multi-layered core shell toner particle having no special surface features.

FIGS. 3-7 are scanning electron images, in accordance with the present disclosure showing representative core shell toner particles having special surface features.

FIG. 8 is a scanning electron image, in accordance with the present disclosure showing representative multi-layered core shell toner particle having special surface features.

FIG. 9 is a scanning electron image, in accordance with the present disclosure showing representative multi-layered core shell toner particle having special surface features.

FIG. 10 is a graph comparing the charge and charge distribution of a commercially available core shell toner, according to the prior art, to multi-layered core shell toners having toner particles with special surface features, according to the present disclosure.

### DETAILED DESCRIPTION

Toner particles charge when a material-dependent electric field is created at the surface of the toner particles. Therefore, it is believed that the selection of materials used in the toner formulation may have an influence on the toner surface charge. Moreover, the electron donating/accepting ability difference between the toner and carrier material may have the power to determine the toner charge. Accordingly, raw toner may have the ability to control its own charge. If the base toner charge can be controlled by the toner formulation or process, then the raw toner charge can be modified to an acceptable range and maintained at this level throughout the life of the toner with or without the aid of expensive EPAs and charge control agents. Meanwhile, controlling the charge distribution of the raw toner particles will result in a uniform charge Q/D which benefits toner usage, print quality and print uniformity.

A specially designed polymer latex having styrene and acrylate monomers can be used as an additive to act like a charge control agent in the core or the shell of the toner particle wherein the raw toner's charge and charge distribution can be modified. The compatibility of the styrene-acrylate latex with the polyester resins found in the core and or the shell can be tailored. The compatibility or degree of interaction of the styrene acrylate latex when mixed with the polyester resins in the core or the shell of the toner particle can be controlled by designing a specific styrene acrylic latex. The specially designed styrene acrylic latex is achieved though the selection of 1.) the monomer for the styrene acrylate latex, 2.) the degree of cross-linking, 3.) the molecular chain length, 4.) the glass transition temperature (‘Tg’), and 5.) the quantity and the position of the styrene acrylic latex in the toner particle. This styrene acrylate latex must have certain interactions with the polyester resin so that the styrene acrylic latex and the polyester can be mixed and agglomerated together in an emulsion aggregation toner making process. Additionally, it is desirable that the styrene acrylate latex also maintain its own nano-sized domains in the toner particles.

Surprisingly, the addition of this specially designed styrene acrylic latex into the toner's core or shell changes the surface of the toner particle from a smooth surface to a gritted surface having bumps or protuberances projecting out beyond the surface of the toner particle. These protuberances on the surface of the toner particle are created by controlling the interaction of different polymers, i.e., styrene acrylate and polyester, used in the toner formulation. The toner particle changes from a smooth to a gritted or bumped surface having protuberances on the outer surface of the toner particle. The protuberances appear due to the migration of the self-agglomerated specially designed styrene acrylate latex in the toner particle to the outer surface of the toner particle when the toner is manufactured. Importantly, the specially designed styrene acrylate latex maintains its own nano-sized domains in the toner particles. To form this special surface structure on the outer surface of a toner particle, the less compatible this styrene acrylate latex is with the polyester resin is preferred.

Specific properties of the styrene acrylate latex are chosen to make the interaction between the styrene acrylate latex to be as incompatible as possible with the polyester resin. As set forth above, these specific properties include the monomer selection, the quantity of the cross-linking agent, the chain transfer agent and the surfactant, the molecular chain length, the glass transition temperature and the quantity of the styrene acrylate latex used in the toner formulation.

The specially designed styrene acrylate latex of the present invention is formed from different type of monomers. Hydrophobic monomers may be selected from a group including, but not limited to, styrene, butyl acrylate, lauryl acrylate. Hydrophobic refers to a relatively non-polar type chemical structure that tends to self-associate in the presence of water. Lauryl acrylate or butyl acrylate is used with styrene in the study. Although longer chain length hydrocarbons are preferred for the interaction of the monomer with the wax in the toner, the longer the hydrocarbon chain, the less efficient the monomer is in co-polymerization and more compatible with toner wax. Hydrophilic monomers may be selected from carboxy (—COOH) and hydroxy (—OH) functional groups. The hydrophilic monomers also affect the agglomeration of the toner particle in the emulsion aggregation CPT process. Hydrophilic functionality refers to relatively polar functionality (e.g., a hydrogen bonding group) which may then tend to associate with water molecules. Hydrophilic monomers provide additional stability for the latex particles apart from that already provided by the surfactant and initiator, and compatibility of styrene acrylate latex with the polyester resin. Examples of hydrophilic monomers are hydroxyethyl methacrylate, beta-carboxyethyl acrylate. Furthermore, the quantity of the carboxy and hydroxyl functional groups in the chosen hydrophilic monomers have been found to have a great influence on the print quality and stability of the toner.

The Tg of the styrene acrylate latex is controlled by the monomer ratio, the cross-linking and chain transfer agents. The preferred Tg of the styrene acrylate latex when used in the core is between about 20° C. to about 60° C., preferably about 40° C. to maintain the hardness of the latex. The preferred Tg of the styrene acrylic latex when used in the shell is about 40° C. to 60° C., preferably 50° C.

The quantity of the styrene acrylate latex to be used in the core is about 15%-35 wt %, preferably 20%. The quantity of the styrene acrylate latex to be used in the shell is about 0.5%-2 wt %, preferably 1%.

The cross-linking agent controls the gel content of the latex which, in turn, affects both fusing temperature and the migration of the latex polymers. A relatively high cross-linking the low molecular weight polymer chain is a preferable when considering its compatibility with the polyester resins. In an embodiment, divinyl benzene is useful as a cross-linking agent. Other useful cross-linking agents include any kind of di- or multifunctional meth(acrylate). The quantity of the cross-linking agent to be used in the styrene acrylic latex is about 1.0% to about 2%.

The chain transfer agent not only controls the molecular weight of the latex, but also affects the grit formation of the latex reaction. Generally, any kind of thiol compounds can be a possible chain transfer agent. In the present latex making process, two chain transfer agents are used: 1-dodecanethiol and isooctyl-3-mercaptopropionate. The quantity of the chain transfer agent to be used in the styrene acrylic latex is preferred to be about 1.5% to about 3.5%. The quantity of the chain transfer agent as well as the cross-linking agent influences the migration of the styrene acrylic latex in the toner particle, especially when the styrene acrylic latex is used in the core of the toner particle.

Ammonium persulfate (0.1-0.5% wt) is used in the initiator solution and a surfactant such as AKYPO-M100 (1 to 3% wt) is used together with the organic portion and seed to control the latex particle size around 100 nm. AKYPO-M100 is available from Kao Corporation, Bunka Sumida-ku, Tokyo, Japan.

Example polyester binder(s) to be used in the core and the shell are selected from commercially available resins using acid monomers such as terephthalic acid, trimellitic anhydride, dodecenyl succinic anhydride and fumaric acid. Further, the polyester binder(s) may be formed using alcohol monomers such as ethoxylated and/or propoxylated bisphenol A. Example polyester resins include, but are not limited to, T100, TF-104, NE-1582, NE-701, NE-2141, NE-1569, Binder C, FPESL-2, W-85N, TL-17, TPESL-10, TPESL-11 polyester resins from Kao Corporation, Bunka Sumida-ku, Tokyo, Japan, or mixtures thereof and various commercially available crystalline polyester resin emulsions available from Kao Corporation, Bunka Sumida-ku, Tokyo, Japan and Reichhold Chemical Company, Durham, N.C. under the trade names EPC 2-20, EPC 3-20, 6-20, 7-20, CPES B1, EPC 8-20, EPC 9-20, EPC-10-20, CPES B20 and CPES B25.

Colorants are compositions that impart color or other visual effects to the toner and may include carbon black, dyes (which may be soluble in a given medium and capable of precipitation), pigments (which may be insoluble in a given medium) or a combination of the two. A colorant dispersion may be prepared by mixing the pigment in water with a dispersant. Alternatively, a self-dispersing colorant may be used thereby permitting omission of the dispersant. The colorant may be present in the dispersion at a level of about 5% to about 40% by weight including all values and increments therebetween. For example, the colorant may be present in the dispersion at a level of about 10% to about 15% by weight. The dispersion of colorant may contain particles at a size of about 50 nanometers (nm) to about 500 nm including all values and increments therebetween. Further, the colorant dispersion may have a pigment weight percent divided by dispersant weight percent (P/D ratio) of about 1:1 to about 8:1 including all values and increments therebetween, such as about 2:1 to about 5:1. The colorant may be present at less than or equal to about 15% by weight of the final toner formulation including all values and increments therebetween.

The optional coupling agent used herein is borax (also known as sodium borate, sodium tetraborate, or disodium tetraborate). As used herein, the term borax coupling agent is defined as enabling the formation of hydrogen bonds between polymer chains which assists in the anchoring or binding of the polymer found in the shell onto the surface of the toner core containing the polymers or mixture of polymers, thereby helping to couple the shell to the outer surface of the toner core. The borax coupling agent bonds the shell to the outer surface of the core by forming hydrogen bonding between its hydroxyl groups and the functional groups present in the polymers utilized in the inventive toner formulation.

Typically, coupling agents have multivalent bonding ability. Borax differs from commonly used permanent coupling agents, such as multivalent metal ions (e.g., aluminum and zinc), in that its bonding is reversible. In the electrophotographic process, toner is preferred to have a low fusing temperature to save energy and a low melt viscosity (“soft”) to permit high speed printing at low fusing temperatures. However, in order to maintain the stability of the toner during shipping and storage and to prevent filming of the printer components, toner is preferred to be “harder” at temperatures below the fusing temperature. Borax provides cross-linking through hydrogen bonding between its hydroxy groups and the functional groups of the molecules it is bonded to. The hydrogen bonding is sensitive to temperature and pressure and is not a stable and permanent bond. For example, when the temperature is increased to a certain degree or stress is applied to the polymer, the bond will partially or completely break causing the polymer to “flow” or tear off. The reversibility of the bonds formed by the borax coupling agent is particularly useful in toner because it permits a “soft” toner at the fusing temperature but a “hard” toner at the storage temperature.

The wax used may include any compound that facilitates the release of toner from a component in an electrophotographic printer (e.g., release from a roller surface). The term ‘release agent’ can also be used to describe a compound that facilitates the release of toner from a component in an electrophotographic printer. For example, the release agent or wax may include polyolefin wax, ester wax, polyester wax, polyethylene wax, metal salts of fatty acids, fatty acid esters, partially saponified fatty acid esters, higher fatty acid esters, higher alcohols, paraffin wax, carnauba wax, amide waxes and polyhydric alcohol esters or mixtures thereof.

The wax or release agent may therefore include a low molecular weight hydrocarbon based polymer (e.g., Mn≤10,000) having a melting point of less than about 140° C. including all values and increments between about 50° C. and about 140° C. The wax may be present in the dispersion at an amount of about 5% to about 35% by weight including all values and increments there between. For example, the wax may be present in the dispersion at an amount of about 10% to about 18% by weight. The wax dispersion may also contain particles at a size of about 50 nm to about 1 μm including all values and increments there between. In addition, the wax dispersion may be further characterized as having a wax weight percent divided by dispersant weight percent (RA/D ratio) of about 1:1 to about 30:1. For example, the RA/D ratio may be about 3:1 to about 8:1. The wax is provided in the range of about 2% to about 20% by weight of the final toner formulation including all values and increments there between. Exemplary waxes having these above enumerated characteristics include, but are not limited to, SD-A01, SD-B01, MPA-A02, CM-A01 and CM-B01 from Cytech Products, Inc., Polywax M70, Polywax M80 and Polywax 500 from Baker Petrolite and WE5 from Nippon Oil and Fat.

A surfactant, a polymeric dispersant or a combination thereof may be used. The polymeric dispersant may generally include three components, namely, a hydrophilic component, a hydrophobic component and a protective colloid component. Reference to hydrophobic refers to a relatively non-polar type chemical structure that tends to self-associate in the presence of water. The hydrophobic component of the polymeric dispersant may include electron-rich functional groups or long chain hydrocarbons. Such functional groups are known to exhibit strong interaction and/or adsorption properties with respect to particle surfaces such as the colorant and the polyester binder resin of the polyester resin emulsion. Hydrophilic functionality refers to relatively polar functionality (e.g., an anionic group) which may then tend to associate with water molecules. The protective colloid component includes water soluble group with no ionic function. The protective colloid component of the polymeric dispersant provides extra stability in addition to the hydrophilic component in an aqueous system. Use of the protective colloid component substantially reduces the amount of the ionic monomer segment or the hydrophilic component in the polymeric dispersant. Further, the protective colloid component stabilizes the polymeric dispersant in lower acidic media. The protective colloid component generally includes polyethylene glycol (PEG) groups. The dispersant employed herein may include the dispersants disclosed in U.S. Pat. Nos. 6,991,884 and 5,714,538, which are assigned to the assignee of the present application and are incorporated by reference herein in their entirety.

The surfactant, as used herein, may be a conventional surfactant known in the art for dispersing non self-dispersing colorants and release agents employed for preparing toner formulations for electrophotography. Commercial surfactants such as the AKYPO series of carboxylic acids from AKYPO from Kao Corporation, Bunka Sumida-ku, Tokyo, Japan may be used. For example, alkyl ether carboxylates and alkyl ether sulfates, preferably lauryl ether carboxylates and lauryl ether sulfates, respectively, may be used. One particular suitable anionic surfactant is AKYPO RLM-100 available from Kao Corporation, Bunka Sumida-ku, Tokyo, Japan, which is laureth-11 carboxylic acid thereby providing anionic carboxylate functionality. Other anionic surfactants contemplated herein include alkyl phosphates, alkyl sulfonates and alkyl benzene sulfonates. Sulfonic acid containing polymers or surfactants may also be employed.

The following examples are provided to further illustrate the teachings of the present disclosure, not to limit the scope of the present disclosure.

Example Polyester Resin Emulsions

Preparation of Example Polyester Resin Emulsion A Having a Medium Tg and Medium Tm

A polyester resin having a peak molecular weight of about 11,000, a glass transition temperature (Tg) of about 55° C. to about 58° C., a melt temperature (Tm) of about 115° C., and an acid value of about 8 to about 13 was used. The glass transition temperature is measured by differential scanning calorimetry (DSC), wherein, in this case, the onset of the shift in baseline (heat capacity) thereby indicates that the Tg may occur at about 55° C. to about 58° C. at a heating rate of about 5° C. per minute. The acid value may be due to the presence of one or more free carboxylic acid functionalities (—COOH) in the polyester. Acid value refers to the mass of potassium hydroxide (KOH) in milligrams that is required to neutralize one gram of the polyester. The acid value is therefore a measure of the amount of carboxylic acid groups in the polyester.

150 g of the polyester resin was dissolved in 450 g of methyl ethyl ketone (MEK) in a round bottom flask with stirring. The dissolved resin was then poured into a beaker. The beaker was placed in an ice bath directly under a homogenizer. The homogenizer was turned on at high shear and 3.7 g of 10% potassium hydroxide (KOH) solution and 500 g of de-ionized water were immediately added to the beaker. The homogenizer was run at high shear for about 2-4 minutes then the homogenized resin solution was placed in a vacuum distillation reactor. The reactor temperature was maintained at about 43° C. and the pressure was maintained between about 22 inHg and about 23 inHg. About 500 mL of additional de-ionized water was added to the reactor and the temperature was gradually increased to about 70° C. to ensure that substantially all of the MEK was distilled out. The heat to the reactor was then turned off and the mixture was stirred until it reached room temperature. Once the reactor reached room temperature, the vacuum was turned off and the resin solution was removed and placed in storage bottles.

The particle size of Polyester Resin Emulsion A was between about 190 nm and about 240 nm (volume average) as measured by a NANOTRAC Particle Size Analyzer. The pH of the resin solution was between about 7.5 and about 8.2.

Example Polyester Resin Emulsion B Having a Low Tg and a Low Tm

A polyester resin having a peak molecular weight of about 6500, a glass transition temperature of about 49° C. to about 54° C., a melt temperature of about 95° C., and an acid value of about 21 to about 24 was used to form an emulsion using the procedure outlined making Polyester Resin Emulsion A except using about 12.8 g of the 10% potassium hydroxide (KOH) solution.

The particle size of Polyester Resin Emulsion B was between about 160 nm and about 220 nm (volume average) as measured by a NANOTRAC Particle Size Analyzer. The pH of the resin solution was between about 6.3 and about 6.8.

Preparation of Example Polyester Resin Emulsion C Having a High Tg and a High Tm

A polyester resin having a peak molecular weight of about 13,000, a glass transition temperature of about 58° C. to about 62° C., a melt temperature of about 110° C. and an acid value of about 20 to 23 was used to form an emulsion using the procedure outlined making Polyester Resin Emulsion A except using about 10 g of the 10% potassium hydroxide (KOH) solution.

The particle size of Polyester Resin Emulsion C was between about 190 nm and about 240 nm (volume average) as measured by a NANOTRAC Particle Size Analyzer. The pH of the resin solution was between about 6.5 and about 7.0.

Preparation of Example Crystalline Polyester Resin Emulsion

A crystalline polyester resin having a glass transition temperature of about 82° C. a melt temperature of about 82° C., and an acid value of about 15 to about 18 was used to form an emulsion.

125 g of the crystalline polyester resin was dissolved in 375 g of tetrahydrofuran (THF) in a round bottom flask with heat and stirring. The dissolved resin was then poured into a beaker. The beaker was placed under a homogenizer. The homogenizer was turned on at high shear and 17 g of 10% potassium hydroxide (KOH) solution and 400 g of de-ionized water were immediately added to the beaker. The homogenizer was run at high shear for about 2-4 minutes then the homogenized resin solution was placed in a vacuum distillation reactor. The reactor temperature was maintained at about 43° C. and the pressure was maintained between about 22 inHg and about 23 inHg. About 500 mL of additional de-ionized water was added to the reactor and the temperature was gradually increased to about 60° C. to ensure that substantially all of the THF was distilled out. The heat to the reactor was then turned off and the mixture was stirred until it reached room temperature. Once the reactor reached room temperature, the vacuum was turned off and the resin solution was removed and placed in storage bottles.

The particle size of the crystalline polyester resin emulsion was between about 185 nm and about 235 nm (volume average) as measured by a NANOTRAC Particle Size Analyzer. The pH of the resin solution was about 8.6.

Preparation of Magenta Pigment Dispersion

About 10 g of AKYPO RLM-100 polyoxyethylene(10) lauryl ether carboxylic acid from Kao Corporation, Bunka Sumida-ku, Tokyo, Japan was combined with about 350 g of de-ionized water and the pH was adjusted to ˜7-9 using sodium hydroxide. About 10 g of Solsperse 27000 from Lubrizol Advanced Materials, Cleveland, Ohio, USA was added and the dispersant and water mixture was blended with an electrical stirrer followed by the relatively slow addition of 100 g of pigment red 122. Once the pigment was completely wetted and dispersed, the mixture was added to a horizontal media mill to reduce the particle size. The solution was processed in the media mill until the particle size was about 200 nm. The final pigment dispersion was set to contain about 20% to about 40% solids by weight. The same method is applied to the preparation of the Cyan Pigment Dispersion, except replacing pigment red 122 with pigment blue 15:3.

Preparation of Example Wax Emulsion

About 12 g of AKYPO RLM-100 polyoxyethylene(10) lauryl ether carboxylic acid from Kao Corporation, Bunka Sumida-ku, Tokyo, Japan was combined with about 325 g of de-ionized water and the pH was adjusted to ˜7-9 using sodium hydroxide. The mixture was then processed through a microfluidizer and heated to about 90° C. About 60 g of ester/paraffin wax from Cytec Products Inc., Elizabethtown, Ky. was added to the hot mixture while the temperature was maintained at about 90° C. for about 15 minutes. The emulsion was then removed from the microfluidizer when the particle size was below about 300 nm. The solution was then stirred at room temperature. The wax emulsion was set to contain about 10% to about 40% solids by weight.

General Procedure for the Preparation of the Styrene Acrylic Latex to be Used in Core of Toner

In a flask, 380 g styrene, 170 g butyl acrylate, 17 g β-carboxyethyl acrylate, 1 g divinylbenzene, 9.25 g 1-dodecanethiol, 9.15 g isooctyl-3-mercaptopropionate were weighed and mixed. This served as the organic portion of the reaction. From the organic portion, 58.7 g was weighed out and used as seed.

The initiator solution is prepared in another flask with 109 g of deionized water, 0.44 g of Ammonium persulfate, 80 g of 15% AKYPO-M100 with ammonium hydroxide neutralized.

In a 3 L four-neck, round-bottom flask equipped with a thermocontroller, condenser, mechanical stirrer and nitrogen inlet, about 1140 g deionized water, 40 g of AKYPO 15% surfactant with Ammonium hydroxide were added and heated to 82° C. At 82° C., the organic seed with 0.33 g Ammonium persulfate were added and the reaction mixture held for 25 minutes. The organic and initiator portion were added drop-wise to the reactor while maintaining the temperature at 82° C. The addition continued for approximately three to four hours. At approximately five hours, 0.76 g of t-Butyl hydroperoxide (70%) and 0.51 g of L-Ascorbic acid in 25 ml of deionized water (respectively) were added separately to the reactor. The reaction was held for another two hours and cooled down to room temperature. The product was filtered through a mesh. The final particle size was about 100 nm.

Latexes 1-11 were produced using the procedure outlined in the General Preparation of Latex above, except the different quantity of ingredients as listed in Table 1 below.

TABLE 1

| | Styrene Acrylate Latex | | | | | | | | | | |
|---|---|---|---|---|---|---|---|---|---|---|---|
| | 1 | 2 | 3 | 4 | 5 | 6 | 7 | 8 | 9 | 10 | 11 |
| Hydroxyethyl | | | | | | | | | | | 17.44 |
| methacrylate | | | | | | | | | | | |
| Styrene | 345 | 345 | 327 | 380 | 371 | 412 | 396 | 395 | 400 | 397 | 384 |
| Butyl Acrylate | 210 | 204 | 229 | 169.7 | 180 | 137 | 159 | 159 | 157 | 157 | 165 |
| Beta- Carboxyethyl | 16.9 | 16.9 | 16.9 | 16.9 | 16.9 | 16.9 | 16.9 | 16.9 | 16.9 | 16.9 | 16.9 |
| acrylate | | | | | | | | | | | |
| divinylbenzene | 10.99 | 10.99 | 10.99 | 10.99 | 8.79 | 10.99 | 5.49 | 8.79 | 8.79 | 8.79 | 8.79 |
| 1-Dodecanethiol | 6.16 | 9.25 | 6.17 | 9.25 | 9.25 | 9.25 | 7.71 | 7.71 | 6.17 | 7.71 | 7.71 |
| Isooctyl 3- | 6.1 | 9.15 | 6.1 | 9.15 | 9.15 | 9.15 | 7.63 | 7.63 | 6.1 | 7.63 | 7.63 |
| mercaptopropionate | | | | | | | | | | | |

Preparation of Latexes 12 and 13 to be Used in the Shell of the Toner

In flask A, 2-hydroxyethyl methacrylate 4.48 g, β-carboxyethyl acrylate 2.57 g, 1-Dodecanethiol 1.92 g, Isooctyl-3-mercaptopropionate 1.90 g, styrene 100 g and butyl acrylate 42 g were weighed and mixed.

In flask B, 0.4 g divinylbenzene and 12 g mixture from flask A were mixed as seed.

In flask C, 0.4 g divinylbenzene and 90 g mixture from flask A were mixed.

In flask D, 1.4 g divinylbenzene and the rest of the mixture in flask A were mixed.

The initiator solution is prepared in flask E with 80 g of deionized water, 0.3 g of ammonium persulfate, 8.5 g of 15% Akypo solution and 3.0 g of ammonium hydroxide.

In a 3 L four-neck, round-bottom flask equipped with a thermocontroller, condenser, mechanical stirrer and nitrogen inlet, about 500 g deionized water, 1.6 g of Akypo surfactant and 1.6 g of ammonium hydroxide were added and heated to 82° C. At 82° C., the mixture in flask B with 0.16 g ammonium persulfate were added and held for 25 minutes. The mixture in flask C and initiator solution in flask E were added drop-wise to the reactor in a speed ratio of 3:1 while maintaining the temperature at 82° C. The addition continued for approximately 32 min. until completion. Then the mixture in flask D was added at the same speed. At approximately four hours, 0.19 g of t-butyl hydroperoxide and 0.13 g of L-ascorbic acid in 25 ml of deionized water (respectively) were added separately to the reactor. The reaction was held for another two hours and cooled down to room temperature. The product was filtered through a mesh. The final particle size was around 100 nm. Latex 11 is used as additive in the toner shell resin. Latex 12 was prepared using the same procedure as outlined for the preparation of Latex 11, except 80 grams of mixture from Flask A are used in Flask C.

Preparation of Toners

Control Toner 1

Components were added to a 2 L reactor in the following amounts: about 150 g of polyester resin emulsion B of 29.75% wt, 391.61 g of 29.76% wt Example Polyester Resin Emulsion A, 52.74 g of the Cyan Pigment Dispersion (with 29.10% wt solid and 5:1 Pigment-to-Dispersant ratio), 99.52 g of the 34.40% Example Wax Emulsion with wax-to-dispersant ratio of about 28.5:1, and 834 g of the deionized water.

The mixture was mixed in the reactor at about 25° C. and a circulation loop was started consisting of a high shear mixer and an acid addition pump. The mixture was sent through the loop and the high shear mixer was set at 10,000 rpm. Acid was slowly added to the high shear mixer to evenly disperse the acid in the toner mixture so that there were no pockets of low pH.

Acid addition took about 4 minutes with 210 g of 1% sulfuric acid solution. The flow of the loop was then reversed to return the toner mixture to the reactor and the temperature of the reactor was increased to about 40-45° C. Once the particle size reached 4.5 to 5.0 μm (number average), 5% borax solution (20 g of solution having 1.0 g borax) was added. After the addition of borax, 290.16 g of Example Polyester Resin Emulsion C with 29.70% wt solid was added. The mixture was stirred for about 5 minutes and the pH was monitored. Slowly heat the mixture to about 54° C. Once the particle size reached 5.5 μm (number average), 4% NaOH was added to raise the pH to about 6.7 to stop the particle growth. The reaction temperature was held for one hour. The particle size was monitored during this time period. Once particle growth stopped, the temperature was increased to 93° C. to cause the particles to coalesce. This temperature was maintained until the particles reached their desired circularity (about 0.97-0.98). The toner was then washed and dried. The toner had a volume average particle size of 6.77 μm and a number average particle size of 5.50 μm. Fines (<2 μm) were present at 0.14% (by number) and the toner possessed a circularity of 0.97.

Preparation of Toners 1-11

The preparation of Toners 1-11 followed the same procedure as outlined for the Control Toner 1 except about 45 g (100%) of the identified specially designed Styrene Acrylate Latex replaced the Polyester Resin Emulsion B. Attributes of the different toners tested are listed in Table 2 below. Latex glass transition temperatures for Toners 1-11 were roughly calculated using a monomers ratio calculation. The quantity of cross-linking agent and chain transfer agents are based on the total monomers used by weight. Toner ship/store are measure at 50 C. The presence of the special surface structure was observed with a Scanning Electron Microscope (SEM).

TABLE 2

| | Toner and Styrene Acrylic Latex Used in Core | | | | | | | | | | | |
|---|---|---|---|---|---|---|---|---|---|---|---|---|
| | 1 | 2 | 3 | 4 | 5 | 6 | 7 | 8 | 9 | 10 | 11 | Control 1 |
| Latex Tg | 27 | 21 | 23 | 29.6 | 27 | 42 | 35 | 36 | 37 | 37 | 43 | |
| Cross-Linking wt % | 1.8 | 1.8 | 1.8 | 1.8 | 1.5 | 1.8 | 0.9 | 1.5 | 1.5 | 1.5 | 1.5 | |
| Chain transfer wt % | 2 | 3 | 2 | 3 | 3 | 3 | 2.6 | 2.6 | 2 | 2.6 | 2.6 | |
| Toner ship/store | 57 | 126 | 59 | 86 | 114 | 64 | 89 | 88 | 62 | 58 | 54 | 55 |
| special surface structure | yes | not | yes | yes | yes | yes | yes | yes | less | yes | less | none |
| (SEM) | | clear | | | | | | | | | | |

Preparation of Control Toner 2

In a 5 L reactor, about 244 g of Crystalline Polyester Emulsion with 21.6% wt solid, 592.4 g of 29.76% wt Example Polyester Resin Emulsion A, 34.3 g (100%) of Pigment Red 122 and 18 g Pigment Red 184 (100%) (dispersion with about 30% wt solid and 5:1 pigment-to-dispersant ratio), 210 g of the 34.0% Example Wax Emulsion with wax-to-dispersant ratio of about 28.5:1, and 1600 g of the deionized water.

The mixture was mixed in the reactor at about 25° C. and a circulation loop was started consisting of a high shear mixer and an acid addition pump. The mixture was sent through the loop and the high shear mixer was set at 10,000 rpm. Acid was slowly added to the high shear mixer to evenly disperse the acid in the toner mixture so that there were no pockets of low pH. Acid addition took about 4 minutes with 170 g of 2% sulfuric acid solution. The flow of the loop was then reversed to return the toner mixture to the reactor and the temperature of the reactor was increased to about 40° C. Once the particle size reached 4.0 μm (number average), 353 g of polyester resin emulsion A was added (with 100 g water wash the container). Once the particle size reached 4.7 um, 4% borax solution 21.3 g was added. After the addition of borax, 605 g of Example Polyester Resin Emulsion C with 29.70% wt solid was added. The mixture was stirred for about 5 minutes and the pH was monitored. Once the particle size reached 5.5 μm (number average), 4% NaOH was added to raise the pH to about 7-7.4 to stop the particle growth. The reaction temperature was held for one hour. The particle size was monitored during this time. Once particle growth stopped, the temperature was increased to 93° C. to cause the particles to coalesce. This temperature was maintained until the particles reached their desired circularity. The toner was then washed and dried. The toner had a volume average particle size of 5.96 μm and a number average particle size of 5.30 μm. Fines (<2 μm) were present at 0.72% (by number) and the toner possessed a circularity of 0.965.

Preparation of Toners 12 and 13 Having Styrene Acrylic Latex in the Shell

Components were added to a 2 L reactor in the following amounts: about 122 g of Crystalline Polyester Emulsion with 21.6% wt solid, 296 g of 29.76% wt Example Polyester Resin Emulsion A, 17.1 g (100% wt) of PR122 and 8.9 g (100% wt) PR184 pigment (dispersion about 30% wt solid and 5:1 pigment-to-dispersant ratio), 105 g of the 34.0% Example Wax Emulsion with wax-to-dispersant ratio of about 28.5:1, and 800 g of the deionized water.

The mixture was mixed in the reactor at about 25° C. and a circulation loop was started consisting of a high shear mixer and an acid addition pump. The mixture was sent through the loop and the high shear mixer was set at 10,000 rpm. Acid was slowly added to the high shear mixer to evenly disperse the acid in the toner mixture so that there were no pockets of low pH. Acid addition took about 4 minutes with 85 g of 2% sulfuric acid solution. The flow of the loop was then reversed to return the toner mixture to the reactor and the temperature of the reactor was increased to about 40° C. Once the particle size reached 3.5.0 μm (number average), 176 g of polyester resin emulsion A was added. Then, 252 g of Example Polyester Resin Emulsion C with 29.70% wt solid was added followed by 50 g of the emulsion C mixed with 1% (wt of resin) of the Styrene Acrylate Latex 11 used as additive in the shell. The mixture was stirred for about 5 minutes and the pH was monitored. Once the particle size reached 5.5 μm (number average), 4% NaOH was added to raise the pH to about 7-7.4 to stop the particle growth. The reaction temperature was held for one hour. The particle size was monitored during this time. Once particle growth stopped, the temperature was increased to 83° C. to cause the particles to coalesce. This temperature was maintained until the particles reached their desired circularity. The toner was then washed and dried. The toner had a volume average particle size of 5.05 μm and a number average particle size of 4.43 μm. Fines (<2 μm) were present at 0.91% (by number) and the toner possessed a circularity of 0.979. Toner 13 was made using the same procedure to make Toner 12, except Styrene Acrylic Latex 13 was used as the additive in the shell. The toner had a volume average particle size of 5.33 μm and a number average particle size of 4.56 μm. Fines (<2 μm) were present at 0.21% (by number) and the toner possessed a circularity of 0.98.

Tested attributes of the Toners 12 and 13 are listed in Table 3 below. Latex glass transition temperatures were measured by DSC. The quantity of cross-linking agent and chain transfer agents are based on the total monomers used by weight. The presence of the special surface structure was observed with Scanning Electron Microscope (SEM). Latex 12 and Latex 13 varied in the core/shell monomer ratio.

TABLE 3

| | Toner and Styrene Acrylic Latex Used in Shell | | |
|---|---|---|---|
| | 12 | 13 | Control 2 |
| Latex Tg | 42 | 40 | |
| Cross-Linking wt % | 1.6 | 1.6 | |
| Chain transfer wt % | 2.5 | 2.5 | |
| special surface structure | yes | yes | none |
| (SEM) | | | |

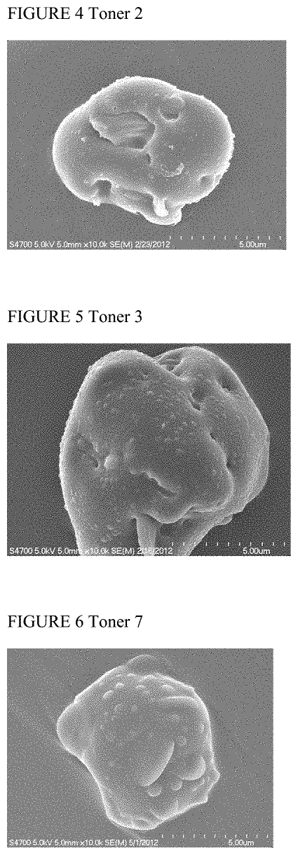

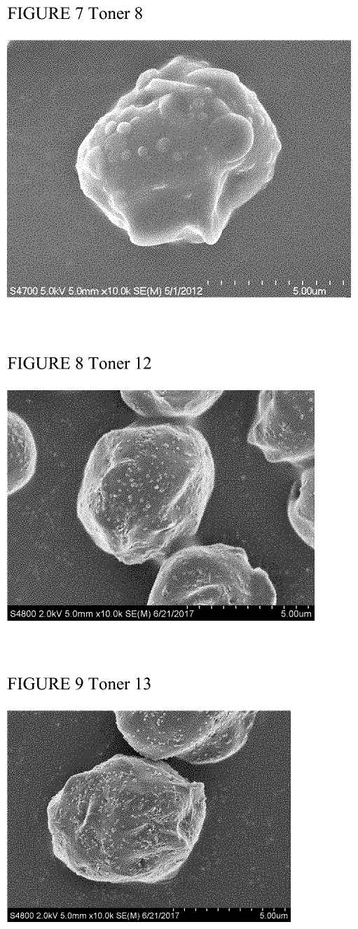

Typically in the general CPT toner particle design, a specific component of the toner is preferred to maintain in the designed specific position in the toner particles. The migration of the component to an undesired position in the toner particle is not preferred and can result in a failure of the function. As shown in FIGS. 3-7, the position of styrene acrylate latexes 1,2,3,7 and 8 in the core of the toner was not maintained as designed and surprisingly migrated to the surface of the toner particle. This phenomenon can be seen by the appearance of the protuberances on the surface of the toner particle in FIGS. 3-9. It is believed that the protuberances or the special surface structure were created because the styrene acrylate has unique chemical, thermal and mechanical properties compared to the polyester resins found in the core and shell of the toner particle.

The incompatibility of the styrene acrylic latex and the polyester resin used in the toner formulation plays an important role for creating the special surface structure or protuberances on the surface of the toner particle. Surprisingly the protuberances function like EPAs and are created when the styrene acrylic latex is tailored to be incompatible with the polyester resin found in the core or shell of the toner. Additionally, it is important that the styrene acrylic latex is maintained in its own nano sized domains in the toner. To create the special surface structure when the styrene acrylate latex is used in the core, lauryl acrylate is not a good choice compared to butyl acrylate. A styrene acrylic latex containing long chain hydrocarbon monomers such as lauryl acrylate and octyltrimethoxysilane as well as the hydroxyethyl methacrylate do not create the special surface structure when used in the core because these long chain hydrocarbon monomers are too compatible with either the polyester resins and/or with the wax used in the core of the toner. As a result of this compatibility, the styrene acrylate latex loses its own domain and is mixed with the polyester resins and or wax found in the core.

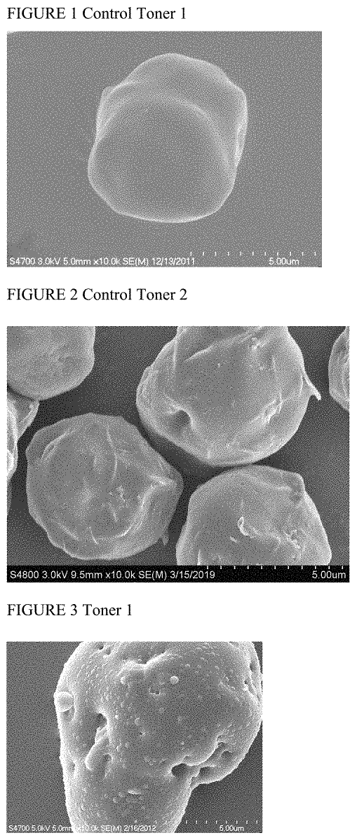

FIG. 1 and FIG. 2 are SEMs of Control Toner 1 and Control Toner 2 and show the toner particles in these two toners having a very smooth surface. FIGS. 3-7 are SEMs of Toners 1,2,3,7 and 8 wherein the specially designed styrene acrylate latex is added in the core of the toner particle. The only difference between the formulation for Toners 1,2 3,7 and 8 and Control Toner 1 is the addition of the specially designed styrene acrylic latex in the core. As can be seen from FIGS. 3-7, the surface of the toner particles has a grit-like surface or protuberances on the surface of the toner particle in Toners 1,2,3,7, and 8. These protuberances occur on the surface of the toner particle due to the migration of the specially designed styrene acrylic latexes 1,2,3,7 and 8 onto the surface of the toner particle.

FIGS. 8 and 9 are SEMs of toner particles in Toners 11 and 12 wherein the specially designed styrene acrylic latex is added to the shell. The only difference between the formulation of Toners 11 and 12 and Control Toner 2 is the addition of the specially designed styrene acrylic latexes 11 and 12 into the toner shell. As can be seen from FIGS. 8 and 9, the surface of the toner particles has a grit-like surface or protuberances on the surface of the toner particle in Toners 11 and 12. These protuberances occur on the surface of the toner particle due to the migration of the specially designed styrene acrylic latexes 11 and 12 onto the surface of the toner particle.

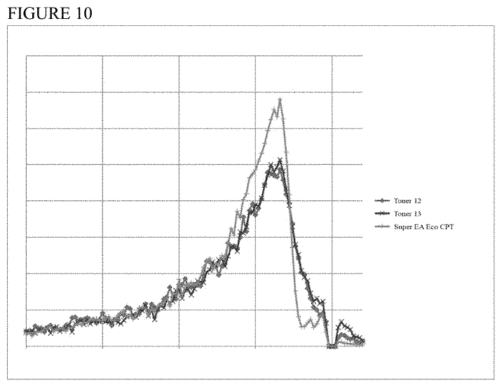

The addition of the specially designed styrene acrylate latexes 12 and 13 into the shell of Toners 12 and 13 can be used to control the raw toner charge and charge distribution of the toners. FIG. 10 compares the charge and charge distribution of Xerox® Super EA Eco toner to Toners 12 and 13. Toners 12 and 13 have the specially designed styrene acrylate latexes 12 and 13 as an additive in their respective toner shells. As can be seen in FIG. 10, the raw toner charge and charge distribution of Toners 12 and 13 are similar to the raw toner charge and charge distribution of Xerox® Super EA Eco toner treated with expensive EPAs. FIGS. 8 and 9 show Toners 12 and 13 having the special surface structure containing protuberances located on the surface of the toner particle. These protuberances provide a strong and special electron donating/accepting capability compared to Control Toner 2 having only a polyester resin in its shell, which in turn narrows the charge distribution of Toners 12 and 13. Accordingly, it is possible to utilize the specially designed styrene acrylate latex's incompatibility with polyester resin and the surprising migration of this specially designed styrene acrylic latex to the surface of the toner particle to control the raw toner charge and charge distribution. Moreover, by creating this gritted surface having protuberances on the surface of the toner particle, the raw toner or base powder can maintain a narrow charge without the use of charge control agents and or expensive EPAs. This is especially important because later in the life of the toner, EPAs are dropped out or become dislodged from the surface of the toner. Having a toner not dependent of the use of EPAs ultimately benefits the toner usage and energy minimization (TEC′ or typical energy consumption) in EP printing.

1. A method for producing toner, comprising:
combining and agglomerating a first polymer emulsion with a colorant dispersion, a release agent dispersion to form toner cores;
adding a borax coupling agent to the toner cores;
combining and agglomerating a second polymer emulsion and a polymer latex including a hydrophilic monomer having one of a carboxyl (—COOH) functional group and a hydroxyl (—OH) functional group and hydrophobic styrene and acrylate monomers with the toner cores having the borax coupling agent to form toner shells around the toner cores; and
fusing the aggregated toner cores and toner shells to form toner particles, wherein the toner that is produced has special surface features on its outer surface and the polymer latex is used to control the raw toner charge and charge distribution of the toner.

2. The method of claim 1, wherein the hydrophobic acrylate monomer is an alkyl acrylate.

3. The method of claim 2, where the alkyl acrylate monomer is lauryl acrylate.

4. The method of claim 1, wherein the hydrophilic monomer having one of a carboxyl (—COOH) functional group is beta-carboxyethyl acrylate.

5. The method of claim 1, wherein the hydrophilic monomer having one of a hydroxyl (—OH) functional groups is hydroxyethyl methacrylate.

6. A method for producing toner, comprising:
combining a first polymer emulsion with a colorant dispersion and a release agent to form toner cores;
adjusting the pH of the combination of the first polymer emulsion, the colorant dispersion, and the release agent dispersion and the polymer latex to promote agglomeration of the toner cores;
once the toner cores reach a predetermined size, adding a borax coupling agent to the toner cores;
combining a second polymer emulsion and a polymer latex including a hydrophilic monomer having one of a carboxyl (—COOH) functional group and a hydroxyl (—OH) functional group and hydrophobic styrene and acrylate monomers dispersion with the toner cores having the borax coupling agent and forming toner shells around the toner cores;
once a desired toner particle size is reached, adjusting the pH of the mixture of aggregated toner cores and toner shells to prevent additional particle growth; and
fusing the aggregated toner cores and toner shells to form toner particles.

7. The method of claim 6, wherein the hydrophobic acrylate monomer is an alkyl acrylate.

8. The method of claim 7, where the alkyl acrylate monomer is lauryl acrylate.

9. The method of claim 6, wherein the hydrophilic monomer having one of a carboxyl (—COOH) functional group is beta-carboxyethyl acrylate.

10. The method of claim 6, wherein the hydrophilic monomer having one of a hydroxyl (—OH) functional groups is hydroxyethyl methacrylate.
